(19) United States
(12) Patent Application Publication
(10) Pub. No.: US 2016/0203334 A1
(43) Pub. Date: Jul. 14, 2016

(54) METHOD AND APPARATUS FOR UTILITY-AWARE PRIVACY PRESERVING MAPPING IN VIEW OF COLLUSION AND COMPOSITION

(71) Applicant: THOMSON LICENSING, Issy Les Moulineaux (FR)

(72) Inventors: Nadia Fawaz, Santa Clara, CA (US); Abbasali Makhdoumi Kakhaki, Somerville, MA (US)

(73) Assignee: Thomson Licensing, Issy Les Moulineaux (FR)

(21) Appl. No.: 14/912,689

(22) PCT Filed: Nov. 21, 2013
(86) PCT No.: PCT/US2013/071287

§ 371 Date: Feb. 18, 2016

Related U.S. Application Data
(60) Provisional application No. 61/867,544, filed on Aug. 19, 2013.

(51) Int. Cl. G06F 21/62

(52) U.S. Cl. CPC G06F 21/6245

(57) ABSTRACT

The present embodiments focus on the privacy-utility tradeoff encountered by a user who wishes to release some public data to an analyst, which is correlated with his private data, in the hope of getting some utility. When multiple data are released to one or more analyst, we design privacy preserving mappings in a decentralized fashion. In particular, each privacy preserving mapping is designed to protect against the inference of private data from each of the released data separately. Decentralization simplifies the design, by breaking one large joint optimization problem with many variables into several smaller optimizations with fewer variables.

### CROSS-REFERENCE TO RELATED APPLICATIONS

This application claims the benefit of the filing date of the following U.S. Provisional application, which is hereby incorporated by reference in its entirety for all purposes: Ser. No. 61/867,544, filed on Aug. 19, 2013, and titled “Method and Apparatus for Utility-Aware Privacy Preserving Mapping in View of Collusion and Composition.”

This application is related to U.S. Provisional Patent Application Ser. No. 61/691,090 filed on Aug. 20, 2012, and titled “A Framework for Privacy against Statistical Inference” (hereinafter “Fawaz”). The provisional application is expressly incorporated by reference herein in its entirety.

In addition, this application is related to the following applications: (1) Attorney Docket No. PU130120, entitled “Method and Apparatus for Utility-Aware Privacy Preserving Mapping against Inference Attacks,” and (2) Attorney Docket No. PU130122, entitled “Method and Apparatus for Utility-Aware Privacy Preserving Mapping through Additive Noise,” which are commonly assigned, incorporated by reference in their entireties, and concurrently filed herewith.

### TECHNICAL FIELD

This invention relates to a method and an apparatus for preserving privacy, and more particularly, to a method and an apparatus for preserving privacy of user data in view of collusion or composition.

### BACKGROUND

In the era of Big Data, the collection and mining of user data has become a fast growing and common practice by a large number of private and public institutions. For example, technology companies exploit user data to offer personalized services to their customers, government agencies rely on data to address a variety of challenges, e.g., national security, national health, budget and fund allocation, or medical institutions analyze data to discover the origins and potential cures to diseases. In some cases, the collection, the analysis, or the sharing of a user's data with third parties is performed without the user's consent or awareness. In other cases, data is released voluntarily by a user to a specific analyst, in order to get a service in return, e.g., product ratings released to get recommendations. This service, or other benefit that the user derives from allowing access to the user's data may be referred to as utility. In either case, privacy risks arise as some of the collected data may be deemed sensitive by the user, e.g., political opinion, health status, income level, or may seem harmless at first sight, e.g., product ratings, yet lead to the inference of more sensitive data with which it is correlated. The latter threat refers to an inference attack, a technique of inferring private data by exploiting its correlation with publicly released data.

### BRIEF DESCRIPTION OF THE DRAWINGS

FIG. 1 is a pictorial example illustrating collusion and composition.

FIG. 2 is a flow diagram depicting an exemplary method for preserving privacy, in accordance with an embodiment of the present principles.

FIG. 3 is a flow diagram depicting another exemplary method for preserving privacy, in accordance with an embodiment of the present principles.

FIG. 4 is a block diagram depicting an exemplary privacy agent, in accordance with an embodiment of the present principles.

FIG. 5 is a block diagram depicting an exemplary system that has multiple privacy agents, in accordance with an embodiment of the present principles.

### SUMMARY

The present principles provide a method for processing user data for a user, comprising the steps of: accessing the user data, which includes private data, a first public data and a second public data, the first public data corresponding to a first category of data, and the second public data corresponding to a second category of data; determining a first information leakage bound between the private data and a first and second released data; determining a second information leakage bound between the private data and the first released data, and a third information leakage bound between the private data and the second released data, responsive to the first information leakage bound; determining a first privacy preserving mapping that maps the first category of data to the first released data responsive the second bound and a second privacy preserving mapping that maps the second category of data to the second released data responsive the third bound; modifying the first and second public data for the user, based on the first and second privacy preserving mappings respectively, to form the first and second released data; and releasing the modified first and second public data to at least one of a service provider and a data collecting agency as described below. The present principles also provide an apparatus for performing these steps.

The present principles also provide a method for processing user data for a user, comprising the steps of: accessing the user data, which includes private data, a first public data and a second public data, the first public data corresponding to a first category of data, and the second public data corresponding to a second category of data; determining a first information leakage bound between the private data and a first and second released data; determining a second information leakage bound between the private data and the first released data, and a third information leakage bound between the private data and the second released data, responsive to the first information leakage bound, wherein each of the second bound and the third bound substantially equals the first bound; determining a first privacy preserving mapping that maps the first category of data to the first released data responsive the second bound and a second privacy preserving mapping that maps the second category of data to the second released data responsive the third bound; modifying the first and second public data for the user, based on the first and second privacy preserving mappings respectively, to form the first and second released data; and releasing the modified first and second public data to at least one of a service provider and a data collecting agency as described below. The present principles also provide an apparatus for performing these steps.

The present principles also provide a computer readable storage medium having stored thereon instructions for processing user data for a user according to the methods described above.

### DETAILED DESCRIPTION

In the database and cryptography literatures from which differential privacy arose, the focus has been algorithmic. In particular, researchers have used differential privacy to design privacy preserving mechanisms for inference algorithms, transporting, and querying data. More recent works focused on the relation of differential privacy with statistical inference. It is shown that differential privacy does not guarantee a limited information leakage. Other frameworks similar to differential privacy exist such as the Pufferfish framework, which can be found in an article by D. Kifer and A. Machanavajjhala, “A rigorous and customizable framework for privacy,” in ACM PODS, 2012, which however does not focus on utility preservation.

Many approaches rely on information-theoretic techniques to model and analyze privacy-accuracy tradeoff. Most of these information-theoretic models focus mainly on collective privacy for all or subsets of the entries of a database, and provide asymptotic guarantees on the average remaining uncertainty per database entry- or equivocation per input variable after the output release. In contrast, the framework studied in the present application provides privacy in terms of bounds on the information leakage that an analyst achieves by observing the released output.

We consider the setting described in Fawaz, where a user has two kinds of data that are correlated: some data that he would like to remain private, and some non-private data that he is willing to release to an analyst and from which he may derive some utility, for example, the release of media preferences to a service provider to receive more accurate content recommendations.

The term analyst, which for example may be a part of a service provider's system, as used in the present application, refers to a receiver of the released data, who ostensibly uses the data in order to provide utility to the user. Often the analyst is a legitimate receiver of the released data. However, an analyst could also illegitimately exploit the released data and infer some information about private data of the user. This creates a tension between privacy and utility requirements. To reduce the inference threat while maintaining utility the user may release a “distorted version” of data, generated according to a conditional probabilistic mapping, called “privacy preserving mapping,” designed under a utility constraint.

In the present application, we refer to the data a user would like to remain private as “private data,” the data the user is willing to release as “public data,” and the data the user actually releases as “released data.” For example, a user may want to keep his political opinion private, and is willing to release his TV ratings with modification (for example, the user's actual rating of a program is 4, but he releases the rating as 3). In this case, the user's political opinion is considered to be private data for this user, the TV ratings are considered to be public data, and the released modified TV ratings are considered to be the released data. Note that another user may be willing to release both political opinion and TV ratings without modifications, and thus, for this other user, there is no distinction between private data, public data and released data when only political opinion and TV ratings are considered. If many people release political opinions and TV ratings, an analyst may be able to derive the correlation between political opinions and TV ratings, and thus, may be able to infer the political opinion of the user who wants to keep it private.

Regarding private data, this refers to data that the user not only indicates that it should not be publicly released, but also that he does not want it to be inferred from other data that he would release. Public data is data that the user would allow the privacy agent to release, possibly in a distorted way to prevent the inference of the private data.

In one embodiment, public data is the data that the service provider requests from the user in order to provide him with the service. The user however will distort (i.e., modify) it before releasing it to the service provider. In another embodiment, public data is the data that the user indicates as being “public” in the sense that he would not mind releasing it as long as the release takes a form that protects against inference of the private data.

As discussed above, whether a specific category of data is considered as private data or public data is based on the point of view of a specific user. For ease of notation, we call a specific category of data as private data or public data from the perspective of the current user. For example, when trying to design privacy preserving mapping for a current user who wants to keep his political opinion private, we call the political opinion as private data for both the current user and for another user who is willing to release his political opinion.

In the present principles, we use the distortion between the released data and public data as a measure of utility. When the distortion is larger, the released data is more different from the public data, and more privacy is preserved, but the utility derived from the distorted data may be lower for the user. On the other hand, when the distortion is smaller, the released data is a more accurate representation of the public data and the user may receive more utility, for example, receive more accurate content recommendations.

In one embodiment, to preserve privacy against statistical inference, we model the privacy-utility tradeoff and design the privacy preserving mapping by solving an optimization problem minimizing the information leakage, which is defined as mutual information between private data and released data, subject to a distortion constraint.

In Fawaz, finding the privacy preserving mapping relies on the fundamental assumption that the prior joint distribution that links private data and released data is known and can be provided as an input to the optimization problem. In practice, the true prior distribution may not be known, but rather some prior statistics may be estimated from a set of sample data that can be observed. For example, the prior joint distribution could be estimated from a set of users who do not have privacy concerns and publicly release different categories of data, which may be considered to be private or public data by the users who are concerned about their privacy. Alternatively when the private data cannot be observed, the marginal distribution of the public data to be released, or simply its second order statistics, may be estimated from a set of users who only release their public data. The statistics estimated based on this set of samples are then used to design the privacy preserving mapping mechanism that will be applied to new users, who are concerned about their privacy. In practice, there may also exist a mismatch between the estimated prior statistics and the true prior statistics, due for example to a small number of observable samples, or to the incompleteness of the observable data.

To formulate the problem, the public data is denoted by a random variable X∈ [symbol] with the probability distribution P_{X}. X is correlated with the private data, denoted by random variable S∈ [symbol] . The correlation of S and X is defined by the joint distribution P_{S,X}. The released data, denoted by random variable Y∈ [symbol] is a distorted version of X. Y is achieved via passing X through a kernel, P_{Y|X}. In the present application, the term “kernel” refers to a conditional probability that maps data X to data Y probabilistically. That is, the kernel P_{Y|X} is the privacy preserving mapping that we wish to design. Since Y is a probabilistic function of only X, in the present application, we assume S→X→Y form a Markov chain. Therefore, once we define P_{Y|X}, we have the joint distribution P_{S,X,Y}=P_{Y|X}P_{S,X} and in particular the joint distribution P_{S,Y}.

In the following, we first define the privacy notion, and then the accuracy notion.

### DEFINITION 1

Assume S→X→Y. A kernel P_{Y|X} is called ε-divergence private if the distribution P_{S,Y} resulting from the joint distribution P_{S,X,Y}=P_{Y|X}P_{S,X} satisfies

$$D ( {P}_{S , Y} \vert \vert {P}_{S} {P}_{Y} ) {=}^{Δ} {𝔼}_{S , Y} [ log \frac{P ( S \vert Y )}{P ( S )} ] {=}^{Δ} I ( S ; Y ) = ε H ( S ) , \qquad ( 1 )$$

where D(.) is the K-L divergence, [symbol] (.) is the expectation of a random variable, H(.) is the entropy, ε∈ [0,1] is called the leakage factor, and the mutual information I(S; Y) represents the information leakage.

We say a mechanism has full privacy if ε=0. In extreme cases, ε=0 implies that, the released random variable, Y, is independent from the private random variable, S, and ε=1 implies that S is fully recoverable from Y (S is a deterministic function of Y). Note that one can assume Y is completely independent from S to have full privacy (ε=0), but, this may lead to a poor accuracy level. We define accuracy as the following.

### DEFINITION 2

Let d: [symbol] × [symbol] → [symbol] ⁺ be a distortion measure. A kernel P_{Y|X} is called D-accurate if [symbol] [d(X, Y) ]≦D.

It should be noted that any distortion metric can be used, such as the Hamming distance if X and Y are binary vectors, or the Euclidian norm if X and Y are real vectors, or even more complex metrics modeling the variation in utility that a user would derive from the release of Y instead of X. The latter could, for example, represent the difference in the quality of content recommended to the user based on the release of his distorted media preferences Y instead of his true preferences X.

There is a tradeoff between leakage factor, E, and distortion level, D, of a privacy preserving mapping. In one embodiment, our objective is to limit the amount of private information that can be inferred, given a utility constraint. When inference is measured by information leakage between private data and released data and utility is indicated by distortion between public data and released data, the objective can be mathematically formulated as to find the probability mapping P_{Y|X} that minimizes the maximum information leakage I(S; Y) given a distortion constraint, where the maximum is taken over the uncertainty in the statistical knowledge on the distribution P_{S,X} available at the privacy agent:

min max I(S;Y),s.t. [symbol] [d(X,Y)]≦D.

The probability distribution P_{S,Y} can be obtained from the joint distribution P_{S,X,Y}=P_{Y|X}P_{S,X}=P_{Y|X}P_{S|X}P_{X}.

In the following, we propose a scheme to achieve privacy (i.e., to minimize information leakage) subject to the distortion constraint, based on some techniques in statistical inference, called maximal correlation. We show how we can use this theory to design privacy preserving mappings without the full knowledge of the joint probability measure P_{S,X}. In particular, we prove a separability result on the information leakage: more precisely, we provide an upper bound on the information leakage in terms of I(S; X) times a maximal correlation factor, which is determined by the kernel, P_{Y|X}. This permits formulating the optimum mapping without the full knowledge of the joint probability measure P_{S,X}.

Next, we provide a definition that is used in stating a decoupling result.

### DEFINITION 3

For a given joint distribution

$${P}_{X , Y} , let {S}^{*} ( X ; Y ) = {sup}_{r ( x ) \neq p ( x )} \frac{D ( r ( y ) \vert \vert p ( y ) )}{D ( r ( x ) \vert \vert p ( x ) )} ,$$

where r(y) is the marginal measure of p(y|x)r(x) on Y.

Note that S*(X; Y)≦1 because of data processing inequality for divergence. The following is a result of an article by V. Anantharam, A. Gohari, S. Kamath, and C. Nair, “On maximal correlation, hypercontractivity, and the data processing inequality studied by Erkip and Cover,” arXiv preprint arXiv:1304.6133, 2013 (hereinafter “Anantharam”).

### Theorem 1.

If S→X→Y form a Markov chain, the following bound holds:

I(S;Y)≦S*(X;Y)I(S;X), (6)

and the bound is tight as we vary S. In other words, we have

$${sup}_{S \text{:} S \to X \to Y} \frac{I ( S ; Y )}{I ( S ; X )} = {S}^{*} ( X ; Y ) , \qquad ( 7 )$$

assuming I(S; X)≠0.

Theorem 1 decouples the dependency of Y and S into two terms, one relating S and X, and one relating X and Y. Thus, one can upper bound the information leakage even without knowing P_{S,X}, by minimizing the term relating X and Y. The application of this result in our problem is the following:

Assume we are in a regime that P_{S,X} is not known and I(S; X)≦Δ for some ΔΣ[0, H(S)]. I(S; X) is the intrinsic information embedded in X about S, which we do not have control on. The value of Δ does not affect the mapping we will find, but the value of Δ affects what we think is the privacy guarantee (in term the leakage factor) resulting from this mapping. If the Δ bound is tight, then the privacy guarantee will be tight. If the Δ bound is not tight, we may then be paying more distortion than is actually necessary for a target leakage factor, but this does not affect the privacy guarantee.

Using Theorem 1, we have

$${min}_{{P}_{Y \vert X}} {max}_{{P}_{S , X}} I ( S ; Y ) = {min}_{{P}_{Y \vert X}} {max}_{{P}_{X}} {max}_{{P}_{S \vert X}} I ( S ; Y ) \leq Δ ( {min}_{{P}_{Y \vert X}} {max}_{{P}_{X}} {S}^{*} ( X ; Y ) ) .$$

Therefore, the optimization problem becomes to find P_{Y|X}, minimizing the following objective function:

$${min}_{{P}_{Y \vert X}} {max}_{{P}_{X}} {S}^{*} ( X ; Y ) \\ s . t . 𝔼 [ d ( X , Y ) ] \leq D . \qquad ( 8 )$$

In order to study this optimization problem in more detail, we review some results in maximal correlation literature. Maximal correlation (or Rényi correlation) is a measure of correlation between two random variables with applications both in information theory and computer science. In the following, we define maximal correlation and provide its relation with S*(X; Y).

### DEFINITION 4

Given two random variables X and Y, the maximal correlation of (X, Y) is

$${ρ}_{m} ( X ; Y ) = {max}_{( f ( X ) , g ( Y ) ) ∈ 𝒯} 𝔼 [ f ( X ) g ( Y ) ] , \qquad ( 9 )$$

where [symbol] is the collection of pairs of real-valued random variables f(X) and g(Y) such that [symbol] [f(X)]= [symbol] [g(Y)]=0 and [symbol] [f(X)²]= [symbol] [g(Y)²]=1.

This measure was first introduced by Hirschfeld (H. O. Hirschfeld, “A connection between correlation and contingency,” in Proceedings of the Cambridge Philosophical Society, vol. 31) and Gebelein (H. Gebelein, “Das statistische Problem der Korrelation als Variations-und Eigenwert-problem und sein Zusammenhang mit der Ausgleichungsrechnung,” Zeitschrift fur angew. Math. und Mech. 21, pp. 364-379 (1941)), and then studied by Rényi (A. Rényi, “On measures of dependence,” Acta Mathematica Hungarica, vol. 10, no. 3). Recently, Anantharam et al. and Kamath et al. (S. Kamath and V. Anantharam, “Non-interactive simulation of joint distributions: The hirschfeld-gebelein-rényi maximal correlation and the hypercontractivity ribbon,” in Communication, Control, and Computing (Allerton), 2012 50th Annual Allerton Conference on, hereinafter “Kamath”) studied the maximal correlation and provided a geometric interpretation of this quantity. The following is a result of an article by R. Ahlswede and P. Gács, “Spreading of sets in product spaces and hypercontraction of the markov operator,” The Annals of Probability (hereinafter “Ahlswede”):

$${max}_{{P}_{X}} {ρ}_{m}^{2} ( X ; Y ) = {max}_{{P}_{X}} {S}^{*} ( X ; Y ) . \qquad ( 10 )$$

Substituting (10) in (8), the privacy preserving mapping is the solution of

$${min}_{{P}_{Y \vert X}} {max}_{{P}_{X}} {ρ}_{m}^{2} ( X ; Y )$$

s.t. [symbol] [d(X;Y)]≦D. (11)

It is shown in an article by H. S. Witsenhausen, “On sequences of pairs of dependent random variables,” SIAM Journal on Applied Mathematics, vol. 28, no. 1 that, maximal correlation, ρₘ(X;Y) is characterized by the second largest singular value of the matrix Q with entries

$${Q}_{x , y} = \frac{P ( x , y )}{\sqrt{P ( x ) P ( y )}} .$$

The optimization problem can be solved by power iteration algorithm or Lanczos algorithm for finding singular values of a matrix.

In the above, we discuss how privacy preserving mappings can be designed using the separability result in Theorem 1. The methods discussed above are among the techniques which can be used to address new challenges in the design of privacy preserving mapping mechanisms, that arise when multiple data releases to one or several analyst occur. In the present application, we provide privacy mapping mechanisms in view of collusion or composition.

In the following, we define the challenges under collusion and composition.

Collusion: a private data, S, is correlated with two public data, X₁ and X₂. Two privacy preserving mappings are applied on these public data to obtain two released data, Y₁ and Y₂, respectively, which are then released to two analysts. We wish to analyze the cumulative privacy guarantees on S when the analysts share Y₁ and Y₂. In the present application, we also refer to the analysts that share Y₁ and Y₂ as colluding entities.

We focus on the case where the two privacy-preserving mappings are designed in a decentralized fashion: Each privacy preserving mapping is designed to protect against the inference of S from each of the released data separately. Decentralization simplifies the design, by breaking one large optimization with many variables (joint design) into several smaller optimizations with fewer variables.

Composition: a private data S is correlated with the public data, X₁ and X₂ through the joint probability distribution P(S; X₁; X₂). Assume that we are able to design separately two privacy preserving mappings, where one mapping transforms X₁ into Y₁, and the other mapping transforms X₂ into Y₂. An analyst requests the pair (X₁, X₂). We wish to re-use these two separate privacy mappings to generate a privacy preserving mapping for the pair (X₁, X₂), which still guarantees a certain level of privacy.

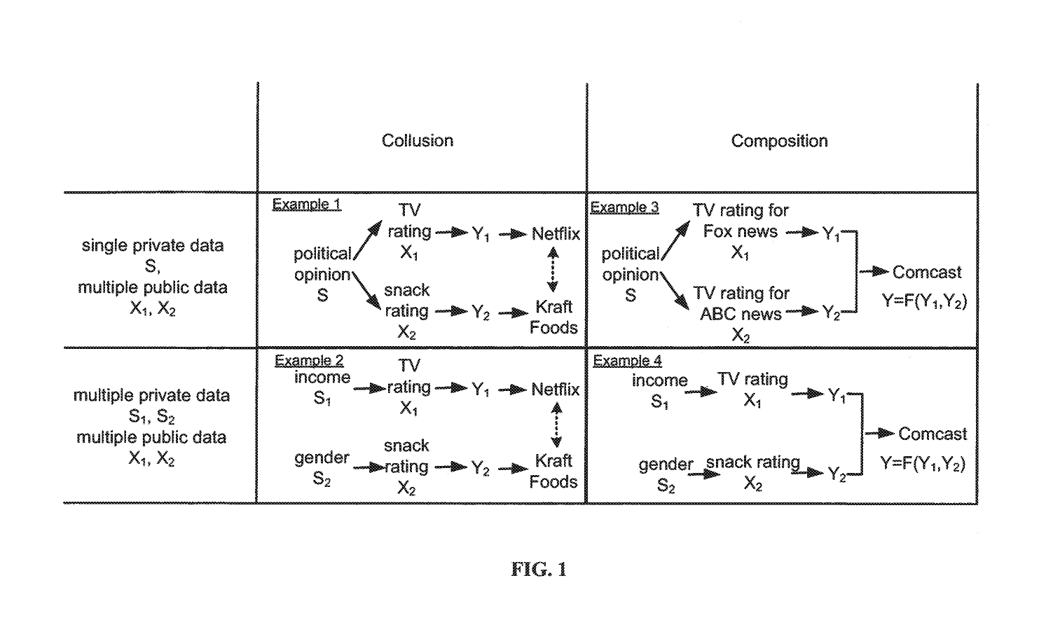

FIG. 1 provides examples on collusion and composition:

Example 1: collusion when a single private data and multiple public data are considered;

Example 2: collusion when multiple private data and multiple public data are considered;

Example 3: composition when a single private data and multiple public data are considered; and

Example 4: composition when multiple private data and multiple public data are considered.

In Example 1, a private data, S, is correlated with two public data, X₁ and X₂.

In this example, we consider political opinion as private data S, TV rating as public data X₁ and snack rating as public data X₂. Two privacy preserving mappings are applied on these public data to obtain two released data, Y₁ and Y₂ provided to two entities, respectively. For example, the distorted TV rating (Y₁) is provided to Netflix, and the distorted snack rating (Y₂) is provided to Kraft Foods. The privacy preserving mappings are designed in a decentralized fashion. Each of the privacy preserving mapping schemes is designed to protect S from the corresponding analyst. If Netflix exchanges information (Y₁) with Kraft (Y₂), the user's private data (S) may be recovered more accurately than if they only depend on Y₁ or Y₂ alone. We wish to analyze the privacy guarantees when the analysts share Y₁ and Y₂. In this example, Netflix is a legitimate receiver of information about TV rating, but not snack rating, and Kraft Foods is a legitimate receiver of information about snack rating, but not TV rating. However, they may share information in order to infer more about the user's private data.

In Example 2, private data S₁ is correlated with public data X₁, and private data S₂ is correlated with public data X₂. In this example, we consider income as private data S₁, gender as private data S₂, TV rating as public data X₁ and snack rating as public data X₂. Two privacy preserving mappings are applied on these public data to obtain two released data, Y₁ and Y₂ provided to two analysts, respectively.

In Example 3, a private data, S is correlated with public data X₁ and X₂ through joint probability distribution P_{S,X}_{₁}_{,X}_{₂}. In this example, we consider political opinion as private data S, TV rating for Fox news as public data X₁ and TV rating for ABC news as public data X₂. An analyst, for example, Comcast asks for both X₁ and X₂. Again, the privacy preserving mappings are designed separately and we want to analyze the privacy guarantees when the privacy agent combines her information Y₁ and Y₂ about both S₁ and S₂. In this example, Comcast is an legitimate receiver of both TV ratings for Fox news and ABC news.

In Example 4, two private data, S₁ and S₂ are correlated with public data, X₁ and X₂ through joint probability distribution P_{S}_{₁}_{,S}_{₂}_{,X}_{₁}_{,X}_{₂}. In this example, we consider income as private data S₁, gender as private data S₂, TV rating as public data X₁ and snack rating as public data X₂.

As discussed above, multiple random variables (for example, X₁ and X₂) are involved when there is collusion or composition. However, mappings for large size X (large vector with multiple variables) are more difficult to design than mappings for small size X (possibly one variable, or a small vector), as the complexity of the optimization problem which provides a solution to the privacy mapping scales with the size of vector X.

In one embodiment, we simplify the design of the optimization problem by breaking one large optimization with many variables into several smaller optimization with less variables.

Both collusion and composition problems can be captured in the following setting.

Assume a private random variable S is correlated with X₁ and X₂. Distorted versions of X₁ and X₂ are denoted by Y₁ and Y₂, respectively. We perform two separate privacy preserving mappings, P(Y₁|X₁) and P(Y₂|X₂), on X₁ and X₂ to obtain Y₁ and Y₂, respectively given distortion constraints. The individual information leakages are I(S; Y₁) and I(S; Y₂). Assume that Y₁ and Y₂ are combined together into a pair (Y₁, Y₂), either by colluding entities, or by a privacy agent through composition.

In the present principles, we address the question of how privacy guarantees combine under multiple releases, i.e., the question of obtaining the resulting cumulative information leakage when multiple released data are combined, either through composition or collusion. The rules of combination of privacy guarantees help in addressing the issue of colluding entities, who share data that is released to them individually in order to improve their inference of private data. Combination rules also help in the design of privacy preserving mapping mechanisms by allowing to break the joint design for multiple pieces of data into several simpler design problems for individual pieces of data.

The combination of privacy preserving schemes is studied in several existing works. The focus of these works is on differential privacy in the presence of collusion or composition. However, the present principles consider privacy in the presence of collusion or composition under an information-theoretic privacy metric.

In the following, we first discuss the case where the releases are related to the same private data (e.g., Example 1 and Example 3), and then extend the analysis to the case where the releases are related to different but correlated pieces of private data (e.g., Example 2 and Example 4).

### Single Private Data, Multiple Public Data

Assume a private random variable S is correlated with X₁ and X₂. Distorted versions of X₁ and X₂ are denoted by Y₁ and Y₂, respectively. We perform two separate privacy preserving mappings on X₁ and X₂ to obtain Y₁ and Y₂, respectively. P_{Y}_{₁}_{|X}_{₁} and P_{Y}_{₂}_{|X}_{₂}, are designed with given distortion constraints, and the individual information leakages are I(S; Y₁) and I(S; Y₂), respectively. Assume the two released data Y₁ and Y₂ are combined together into a pair (Y₁, Y₂), either by colluding entities, or by a privacy agent through composition. We want to analyze the resulting cumulative privacy leakage I(S; Y₁, Y₂) under this combination of information.

### Lemma 1.

Assume Y₁, Y₂, and S form a Markov chain in any order. If the privacy preserving mappings leak I(Y₁; S) and I(Y₂; S) bits by Y₁ and Y₂, respectively, then at most I(Y₁; S)+I(Y₂; S) bits of information are leaked by the pair Y₁ and Y₂. In other words, I(Y₁, Y₂; S)≦I(Y₁; S)+I(Y₂; S). Moreover, if S→Y₁→Y₂, then I(S; Y₁, Y₂)≦I(Y₁; S). If S→Y₂→Y₁, then I(S; Y₁, Y₂)≦(Y₂; S).

Proof: Note that if three random variables form a Markov chain, A→B→C, then we have I(A; B)≧I(A; B|C), I(B; C)≧I(B; C|A), and I(A; C|B)=0. The proof follows from this fact. □

Lemma 1 applies regardless of how much knowledge on P_{S,X} is available when the mapping is designed. The bounds in Lemma 1 holds when P_{S,X} is known. It also holds if the privacy preserving mappings are designed using the method based on the separability result in Theorem 1.

Note that using Y₁ and Y₂ together might lead to full recovery of S. For instance, let S, Y₁, and Y₂ be three Bern

$$( \frac{1}{2} )$$

random variables such that S=Y₁⊕Y₂ and Y₁␣Y₂. Then, we have I(Y₁; S)=I(Y₂; S)=0, whereas I(Y₁, Y₂; S)=1 bit and S is fully recoverable from (Y₁, Y₂). Another example is when Y₁=S+N where N is some noise and Y₂=S−N. We can fully recover S by adding Y₁ and Y₂.

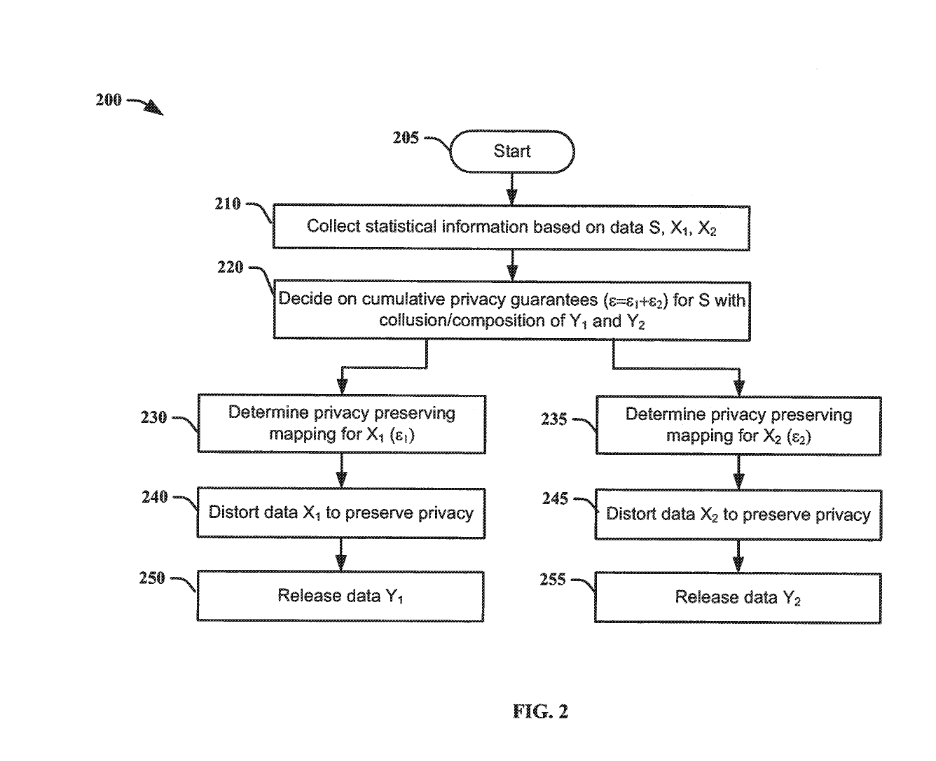

FIG. 2 illustrates an exemplary method 200 for preserving privacy in view of collusion or composition, in accordance with an embodiment of the present principles. Method 200 starts at step 205. At step 210, it collects statistical information based on the single private data S and public data X₁ and X₂. At step 220, it decides the cumulative privacy guarantee for the private data S in view of collusion or composition of released data Y₁ and Y₂. That is, it decides a leakage factor ε for I(S; Y₁, Y₂).

Following Lemma 1, the privacy preserving mappings are designed in a decentralized fashion for public data X₁ and X₂. At step 230, it determines a privacy preserving mapping P_{Y}_{₁}_{|X}_{₁} for public data X₁, given leakage factor ε₁ for I(S; Y₁). Similarly, at step 235, it determines a privacy preserving mapping P_{Y}_{₂}_{|X}_{₂}, for public data X₂, given leakage factor ε₂ for I(S; Y₂).

In one embodiment, we may set ε=ε₁+ε₂, for example, ε₁=ε₂=ε/2. According to the privacy preserving mappings designed at steps 230 and 235,

I(S;Y₁)≦ε₁H(S),I(S;Y₂)≦ε₂H(S),

Using Lemma 1, we have

I(Y₁,Y₂;S)≦I(Y₁;S)+I(Y₂;S)≦ε₁H(S)+ε₂H(S)≦εH(S)

At steps 240 and 245, we distort data X₁ and X₂ according to privacy preserving mappings P_{Y}_{₁}_{|X}_{₁} and P_{Y}_{₂}_{|X}_{₂}, respectively. At steps 250 and 255, the distorted data are released as Y₁ and Y₂, respectively.

As discussed before, collusion may occur when a legitimate receiver of released data Y₁ (but not Y₂) exchanges information about Y₂ with a legitimate receiver of released data Y₂ (but not Y₁). On the other hand, for composition, both released data are legitimately received by the same receiver, and composition occurs when the receiver combines information from both released data to infer more information about the user.

Next, we use the results on maximal correlation to upper bound the cumulative amount of information leaked by the pair Y₁ and Y₂.

### Theorem 4.

Let P_{Y}_{₁}_{|X}_{₁} and P_{Y}_{₂}_{|X}_{₂} be designed separately, i.e., P_{Y}_{₁}_{,Y}_{₂}_{|X}_{₁}_{,X}_{₂}=P_{Y}_{₁}_{|X}_{₁}P_{Y}_{₂}_{|X}_{₂}, and λ=max {S*(X₁; Y₁),S*(X₂; Y₂)}. If I(Y₁;Y₂)≧λI(X₁; X₂), then we have

I(S;Y₁,Y₂)≦I(S;X₁,X₂)max{S*(X₁;Y₁),S*(X₂;Y₂)}. (19)

Proof: To prove the theorem we give the following.

### Proposition 4.

Let P_{Y}_{₁}_{,Y}_{₂}_{|X}_{₁}_{,X}_{₂}=P_{Y}_{₁}_{|X}_{₁}P_{Y}_{₂}_{|X}_{₂} and λ=max {S*(X₁; Y₁),S*(X₂; Y₂)}. If I(Y₁; Y₂)≧λI(X₁; X₂), then we have

S*(X₁,X₂;Y₁,Y₂)≦max{S*(X₁;Y₁),S*(X₂;Y₂)}. (20)

Moreover, if X₁ and X₂ are independent (or equivalently, (X₁, Y₁) and (X₂, Y₂) are independent), then we have

S*(X₁,X₂;Y₁,Y₂)=max{S*(X₁;Y₁),S*(X₂;Y₂)}.

First, we prove this proposition. The particular case where independence holds has been previously proved in Anantharam, and the proof for the general case follows the same lines of the proof of tensorization of S*(X; Y) by noting that, I(Y₁; Y₂)≧λI(X₁; X₂) is the only required inequality as mentioned in Anantharam to obtain the inequality (20) (see Anantharam, page 10, part C).

Back to the proof of Theorem 4: Since we have the Markov chain, S→(X₁, X₂)→(Y₁, Y₂), using Theorem 1, we obtain

I(S;Y₁,Y₂)≦I(S;X₁,X₂)S*(X₁,X₂;Y₁,Y₂).

Now, using Proposition 4, concludes the proof. □

Therefore, if both mappings are designed separately with small maximal correlation, then we can still bound the cumulative amount of information leaked by the pair Y₁ and Y₂.

### Corollary 1.

The first term in the upper bound (19), i.e., I(X₁, X₂; S) can be bounded as the following:

If X₁, X₂, and S form a Markov chain in any order, then I(X, X₂; S)≦I(X; S)+I(X; S). Moreover, if S→X₁→X₂, then I(S; X₁, X₂)≦I(X₁; S). If S→X₂→X₁, then I(S; X₁, X₂)≦I(X₂; S).

Proof: the proof is similar to that of Lemma 1.

Note that I(S; Y₁), I(S; Y₂) and I(S; Y₁, Y₂) are less or equal to H(S). If we choose

S*(X₁;Y₁)<ε,S*(X₂;Y₂)<ε,

we get

I(S;Y₁,Y₂)≦I(S;X₁,X₂)max{S*(X₁;Y₁),S*(X₂;Y₂)}≦H(S)max{S*(X₁;Y₁),S*(X₂;Y₂)}≦εH(S).

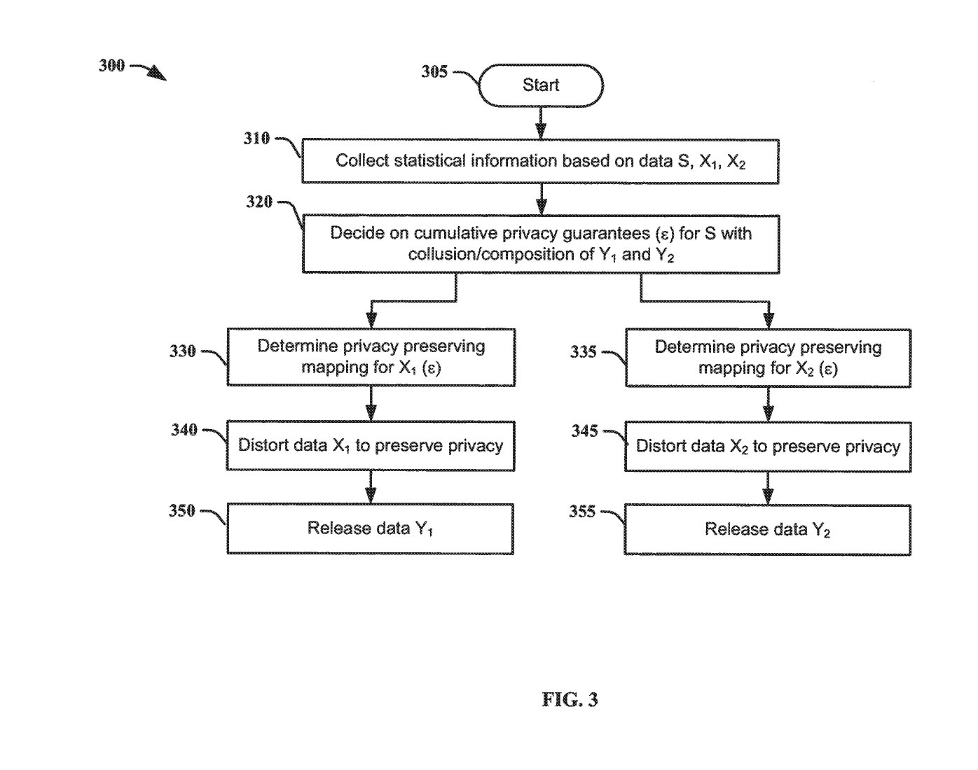

FIG. 3 illustrates an exemplary method 300 for preserving privacy in view of collusion or composition, in accordance with an embodiment of the present principles. Method 300 is similar to method 200, except that S*(X₁; Y₁)<ε (330) and S*(X₂; Y₂)<ε (335). Note that method 200 works under some Markov chain assumptions stated in Lemma 1, while method 300 works more generally.

### Multiple Private Data, Multiple Public Data

Assume we have two private random variables S₁ and S₂, which correlate with X₁ and X₂, respectively. We distort X₁ and X₂ to obtain Y₁ and Y₂, respectively. An analyst has access to Y₁ and Y₂ and wishes to discover (S₁, S₂).

### Theorem 5.

Let P_{Y}_{₁}_{|X}_{₁} and P_{Y}_{₂}_{|X}_{₂} be designed separately, i.e., P_{Y}_{₁}_{,Y}_{₂}_{|X}_{₁}_{,X}_{₂}=P_{Y}_{₁}_{|X}_{₁}P_{Y}_{₂}_{|X}_{₂} and λ=max {S*(X₁; Y₁),S*(X₂; Y₂)}. If I(Y₁; Y₂)≧λI(X₁; X₂), then we obtain

I(S₁,S₂;Y₁,Y₂)≦I(S₁,S₂;X₁,X₂)max{S*(X₁;Y₁),S*(X₂;Y₂)}. (21)

Proof: Similar to the proof of Theorem 4. □

Therefore, the cumulative information leakage of the pair Y₁ and Y₂ is bounded by (21). In particular, if X₁ and X₂ are independent, then this bound holds.

In FIG. 2, we discuss method 200 that determines privacy preserving mappings considering a single private data and two public data in view of collusion or composition. When there are two private data, method 200 can be applied with some modifications. Specifically, at step 210, we collect statistical information based on S₁, S₂, X₁ and X₂. At step 230, we design a privacy preserving mapping P_{Y}_{₁}_{|X}_{₁} for public data X₁, given leakage factor ε₁ for I(S₁; Y₁). At step 235, we design a privacy preserving mapping P_{Y}_{₂}_{|X}_{₂} for public data X₂, given leakage factor ε₂ for I(S₂; Y₂).

Similarly, in FIG. 3, we discuss method 300 that determines privacy preserving mappings considering a single private data and two public data in view of collusion or composition. When there are two private data, method 300 can be applied with some modifications. Specifically, at step 310, we collect statistical information based on S₁, S₂, X₁ and X₂. At step 330, we design a privacy preserving mapping P_{Y}_{₁}_{|X}_{₁} for public data X₁, given leakage factor ε for I(S₁; Y₁). At step 335, we design a privacy preserving mapping P_{Y}_{₂}_{|X}_{₂} for public data X₂, given leakage factor ε for I(S₂; Y₂).

In the above, we discuss about two private data or two public data. The present principles can also be applied when there are more than two private or public data.

A privacy agent is an entity that provides privacy service to a user. A privacy agent may perform any of the following:
receive from the user what data he deems private, what data he deems public, and what level of privacy he wants;
compute the privacy preserving mapping;
implement the privacy preserving mapping for the user (i.e., distort his data according to the mapping); and
release the distorted data, for example, to a service provider or a data collecting agency.

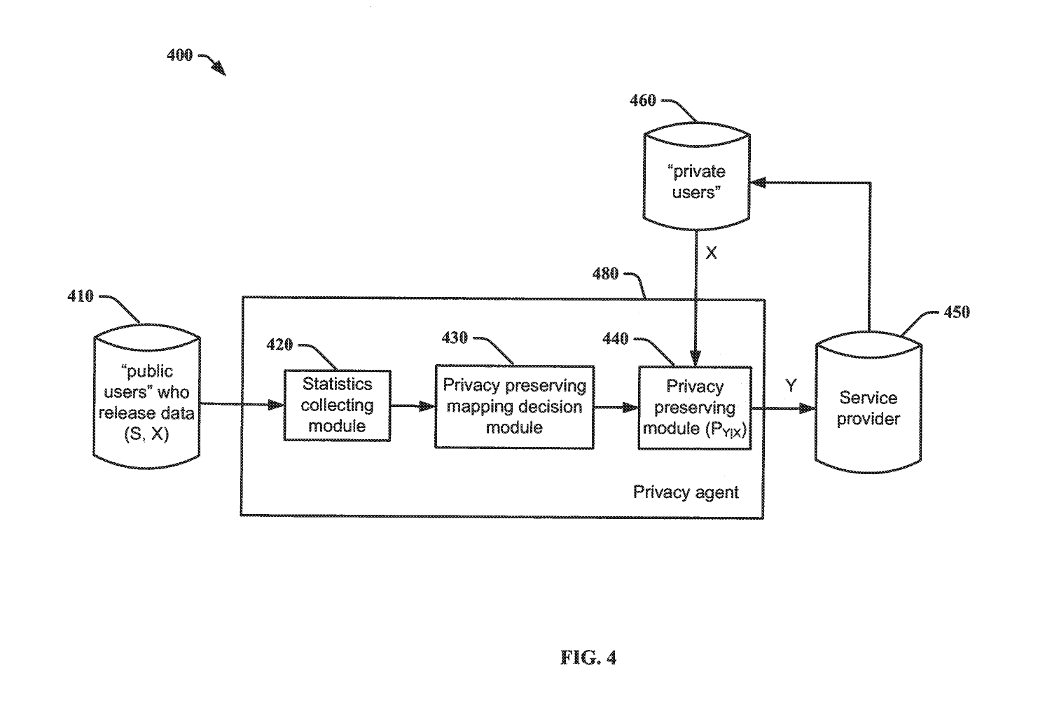

The present principles can be used in a privacy agent that protects the privacy of user data. FIG. 4 depicts a block diagram of an exemplary system 400 where a privacy agent can be used. Public users 410 release their private data (S) and/or public data (X). As discussed before, public users may release public data as is, that is, Y=X. The information released by the public users becomes statistical information useful for a privacy agent.

A privacy agent 480 includes statistics collecting module 420, privacy preserving mapping decision module 430, and privacy preserving module 440. Statistics collecting module 420 may be used to collect joint distribution P_{S,X}, marginal probability measure P_{X}, and/or mean and covariance of public data. Statistics collecting module 420 may also receive statistics from data aggregators, such as bluekai.com. Depending on the available statistical information, privacy preserving mapping decision module 430 designs several privacy preserving mapping mechanisms. Privacy preserving module 440 distorts public data of private user 460 before it is released, according to the conditional probability. When the public data is multi-dimensional, for example, when X include both X₁ and X₂, the privacy preserving module may design separate privacy preserving mappings for X₁ and X₂, respectively, in view of composition. When there is collusion, each colluding entity may use system 400 to design a separate privacy preserving mapping.

Note that the privacy agent needs only the statistics to work without the knowledge of the entire data that was collected in the data collection module and that allowed to compute the statistics. Thus, in another embodiment, the data collection module could be a standalone module that collects data and then computes statistics, and needs not be part of the privacy agent. The data collection module shares the statistics with the privacy agent.

A privacy agent sits between a user and a receiver of the user data (for example, a service provider). For example, a privacy agent may be located at a user device, for example, a computer, or a set-top box (STB). In another example, a privacy agent may be a separate entity.

All the modules of a privacy agent may be located at one device, or may be distributed over different devices, for example, statistics collecting module 420 may be located at a data aggregator who only releases statistics to the module 430, the privacy preserving mapping decision module 430, may be located at a “privacy service provider” or at the user end on the user device connected to a module 420, and the privacy preserving module 440 may be located at a privacy service provider, who then acts as an intermediary between the user, and the service provider to who the user would like to release data, or at the user end on the user device.

The privacy agent may provide released data to a service provider, for example, Comcast or Netflix, in order for private user 460 to improve received service based on the released data, for example, a recommendation system provides movie recommendations to a user based on its released movies rankings.

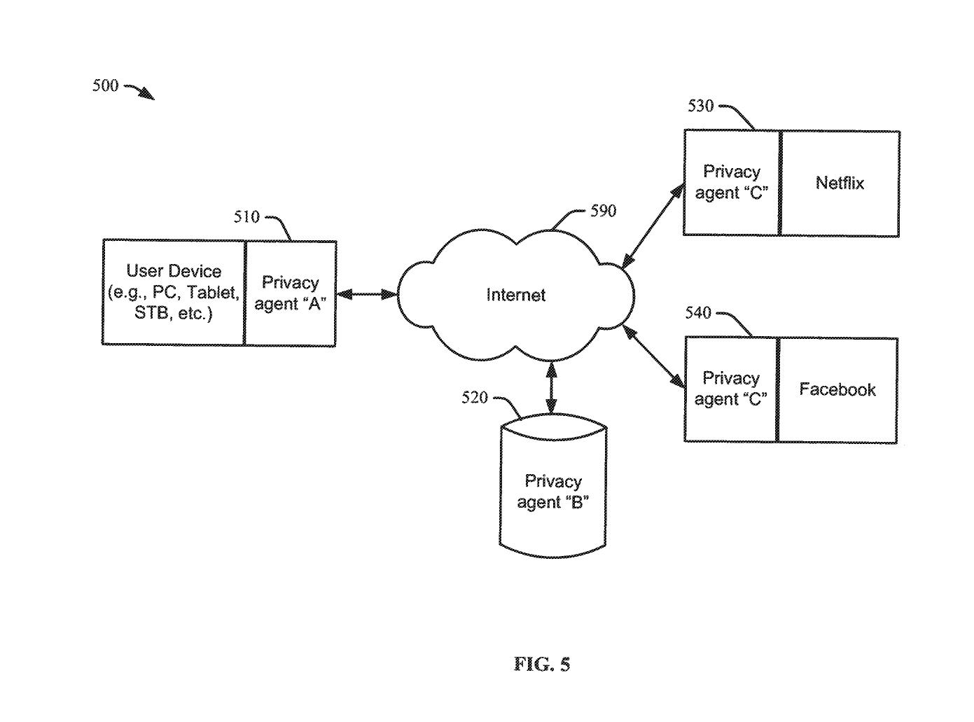

In FIG. 5, we show that there are multiple privacy agents in the system. In different variations, there need not be privacy agents everywhere as it is not a requirement for the privacy system to work. For example, there could be only a privacy agent at the user device, or at the service provider, or at both. In FIG. 5, we show that the same privacy agent “C” for both Netflix and Facebook. In another embodiment, the privacy agents at Facebook and Netflix, can, but need not, be the same.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation” of the present principles, as well as other variations thereof, mean that a particular feature, structure, characteristic, and so forth described in connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, or retrieving the information from memory.

Further, this application or its claims may refer to “accessing” various pieces of information. Accessing the information may include one or more of, for example, receiving the information, retrieving the information (for example, from memory), storing the information, processing the information, transmitting the information, moving the information, copying the information, erasing the information, calculating the information, determining the information, predicting the information, or estimating the information.

Additionally, this application or its claims may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method for processing user data for a user, comprising:
accessing the user data, which includes private data, a first public data and a second public data, the first public data corresponding to a first category of data, and the second public data corresponding to a second category of data;
determining a first information leakage bound between the private data and a first and second released data;
determining a second information leakage bound between the private data and the first released data, and a third information leakage bound between the private data and the second released data, responsive to the first bound;
determining a first privacy preserving mapping that maps the first category of data to the first released data responsive the second bound and a second privacy preserving mapping that maps the second category of data to the second released data responsive the third bound;
modifying the first and second public data for the user, based on the first and second privacy preserving mappings respectively, to form the first and second released data; and
releasing the modified first and second public data to at least one of a service provider and a data collecting agency.

2. The method of claim 1, wherein a combination of the second bound and the third bound substantially corresponds to the first bound.

3. The method of claim 1, wherein each of the second bound and the third bound substantially equals the first bound.

4. The method of claim 1, wherein the releasing step releases the modified first public data to a first receiver and releases the modified second public data to a second receiver, wherein the first and second receivers are configured to exchange information about the modified first and second public data.

5. The method of claim 1, wherein the releasing step releases the modified first and second public data to a same receiver.

6. The method of claim 1, further comprising the step of:
determining whether collusion or composition occurs at the at least one of a service provider and a data collecting agency.

7. The method of claim 1, wherein the steps of determining the first and second privacy preserving mappings are based on maximal correlation techniques.

8. The method of claim 1, wherein the private data includes a first private data and a second private data, wherein the step of determining a second information leakage bound step determines the second bound between the first private data and the first public data and the third bound between the second private data and the second public data.

9. An apparatus for processing user data for a user, comprising:
a processor configured to access the user data, which includes private data, a first public data and a second public data, the first public data corresponding to a first category of data, and the second public data corresponding to a second category of data;
a privacy preserving mapping decision module configured to:
determine a first information leakage bound between the private data and a first and second released data,
determine a second information leakage bound between the private data and the first released data, and a third information leakage bound between the private data and the second released data, responsive to the first bound, and
determine a first privacy preserving mapping that maps the first category of data to the first released data responsive the second bound and a second privacy preserving mapping that maps the second category of data to the second released data responsive the third bound; and
a privacy preserving module configured to:
modify the first and second public data for the user, based on the first and second privacy preserving mappings respectively, to form the first and second released data, and
release the modified first and second public data to at least one of a service provider and a data collecting agency.

10. The apparatus of claim 9, wherein a combination of the second bound and the third bound substantially corresponds to the first bound.

11. The apparatus of claim 9, wherein each of the second bound and the third bound substantially equals the first bound.

12. The apparatus of claim 9, wherein the privacy preserving module releases the modified first public data to a first receiver and releases the modified second public data to a second receiver, wherein the first and second receivers are configured to exchange information about the modified first and second public data.

13. The apparatus of claim 9, wherein the privacy preserving module releases the modified first and second public data to a same receiver.

14. The apparatus of claim 9, wherein the privacy preserving mapping decision module is further configured to determine whether collusion or composition occurs at the at least one of a service provider and a data collecting agency.

15. The apparatus of claim 9, wherein privacy preserving mapping decision module determines the first and second privacy preserving mappings based on maximal correlation techniques.

16. The apparatus of claim 9, wherein the private data includes a first private data and a second private data, and wherein the privacy preserving mapping decision module determines the second information leakage bound between the first private data and the first public data and the third information leakage bound between the second private data and the second public data.

17. (canceled)
